(19) United States
(12) Patent Application Publication
(10) Pub. No.: US 2024/0235228 A1
(43) Pub. Date: Jul. 11, 2024

(54) BATTERY WAKE-UP CIRCUIT IN SERIES-PARALLEL BATTERY SYSTEM

(71) Applicant: ARI ENERGY (HUIZHOU) CO.,LTD, Huizhou (CN)

(72) Inventor: Yingqiang ZHENG, Huizhou (CN)

(73) Assignee: ARI ENERGY (HUIZHOU) CO.,LTD, Huizhou (CN)

(21) Appl. No.: 18/495,065

(22) Filed: Oct. 26, 2023

(30) Foreign Application Priority Data
Jan. 10, 2023 (CN) 202310038100.2

(51) Int. Cl. H02J 7/00

(52) U.S. Cl. CPC H02J 7/0047; H02J 7/0013; H02J 7/0029

(57) ABSTRACT

Disclosed is a battery wake-up circuit in a series-parallel battery system including a battery core assembly, a battery management assembly, a current-limiting charge-discharge switch assembly, a charge-discharge control and detection assembly and a wake-up detection assembly.

The current-limiting charge-discharge switch assembly is provided in series between the battery core assembly and a power output end; and a controlled end of the current-limiting charge-discharge switch assembly is connected to the battery management assembly. The charge-discharge control and detection assembly is connected to the battery management assembly. A detection end of the wake-up detection assembly is connected to the current-limiting charge-discharge switch assembly; and an output end of the wake-up detection assembly is connected to the battery management assembly.

### CROSS-REFERENCE TO RELATED APPLICATIONS

The present application claims priority to Chinese patent application Ser. No. 20/231,0038100.2, filed on Jan. 10, 2023, the entire contents of which are incorporated herein by reference.

### TECHNICAL FIELD

The present application relates to the technical field of battery synchronized wake-up, in particular to a battery wake-up circuit in a series-parallel battery system.

### BACKGROUND

In a battery system built with multiple lithium batteries connected in series and parallel, there is usually only one discharge control switch provided for user operation, and there is usually only one charger-assisted power. In order to ensure that all series and parallel batteries in the system act synchronously under the action of user discharge or charge control signals, the discharge or charge control signals can be connected to each battery through cables or communication devices to achieve synchronization of all batteries and user control signals, such that a large number of cables need to be laid, which not only reduces the reliability of the system, but also increases the cost of installation and maintenance.

### SUMMARY

The main objective of the present application is to provide a battery wake-up circuit in a series-parallel battery system, aiming to solve the problem of low reliability and high installation and maintenance costs caused by laying a large number of cables to deliver a single user discharge control signal or a single charging control signal to all batteries, thereby turning on all the batteries in the system synchronously.

In order to achieve the above-mentioned purposes, the present application provides a battery wake-up circuit in a series-parallel battery system, including:
a battery core assembly;
a battery management assembly;
a current-limiting charge-discharge switch assembly provided in series between the battery core assembly and a power output end; wherein a controlled end of the current-limiting charge-discharge switch assembly is connected to the battery management assembly;
a charge-discharge control and detection assembly connected to the battery management assembly; wherein the charge-discharge control and detection assembly is configured to detect a signal of a discharge switch and a signal of a charger-assisted power, and wake up the battery management assembly in response to detecting a valid signal; and the battery management assembly after being waken up is configured to control the current-limiting charge-discharge switch assembly to realize an electrical connection between the battery core assembly and the power output end, thereby making a current-limiting discharge from the battery core assembly to the power output end; and
a wake-up detection assembly; wherein a detection end of the wake-up detection assembly is connected to one end or two ends of a current-limiting resistor in the current-limiting charge-discharge switch assembly; and an output end of the wake-up detection assembly is connected to the battery management assembly; the wake-up detection assembly is configured to detect a one-end voltage at the one end of the current-limiting resistor or a two-ends voltage difference between the two ends of the current-limiting resistor; and in response to that the one-end voltage or the two-ends voltage difference reaches a preset voltage, the wake-up detection assembly is further configured to output a wake-up detection signal to wake up the battery management assembly which is connected to the wake-up detection assembly.

In some embodiments, the current-limiting charge-discharge switch assembly comprises the current-limiting resistor, a switch transistor and a relay; a first end of the current-limiting resistor is connected to the power output end, and a first end of the switch transistor is connected to one end of the relay; a second end of the switch transistor is connected to a second end of the current-limiting resistor, and a controlled end of the switch transistor is connected to the battery management assembly; the other end of the relay is connected to the battery core assembly.

In some embodiments, the wake-up detection assembly comprises a parallel wake-up detection assembly;
a detection end of the parallel wake-up detection assembly is connected to the first end of the current-limiting resistor, and an output end of the parallel wake-up detection assembly is connected to the battery management assembly; and
the parallel wake-up detection assembly is configured to detect a voltage at the first end of the current-limiting resistor, and in response to that the voltage at the first end of the current-limiting resistor reaches the preset voltage, the parallel wake-up detection assembly is further configured to output a parallel wake-up detection signal to wake up the battery management assembly.

In some embodiments, the wake-up detection assembly further comprises a discharge wake-up detection assembly;
a detection end of the discharge wake-up detection assembly is connected to the two ends of the current-limiting resistor, and an output end of the discharge wake-up detection assembly is connected to the battery management assembly; and
the discharge wake-up detection assembly is configured to detect the two-ends voltage difference between the two ends of the current-limiting resistor, and in response that the two-ends voltage difference reaches the preset voltage, the discharge wake-up detection assembly is further configured to output a discharge wake-up detection signal to wake up the battery management assembly.

In some embodiments, the series-parallel battery system comprises a plurality of lithium batteries connected in series and parallel to each other;
among the plurality of lithium batteries connected in series and parallel to each other, a lithium battery with a highest series voltage is distributed to a high voltage group, and the remaining lithium batteries except the high voltage group are distributed to a low voltage group.

In some embodiments, the parallel wake-up detection assembly comprises a first comparator;
a positive input end of the first comparator is connected to the first end of the current-limiting resistor, and a negative input end of the first comparator is connected to a positive end of a battery core assembly of a lithium battery of the high voltage group; an output end of the first comparator is connected to the battery management assembly; and
the first comparator is configured to compare the voltage at the first end of the current-limiting resistor with a voltage of the positive end of the battery core assembly of the lithium battery of the high voltage group, and output the parallel wake-up detection signal to wake up the battery management assembly.

In some embodiments, the discharge wake-up detection assembly comprises a second comparator;

a positive input end of the second comparator is connected to the second end of the current-limiting resistor, and a negative input end of the second comparator is connected to the first end of the current-limiting resistor; an output end of the second comparator is connected to the battery management assembly; and
the second comparator is configured to compare a voltage at the second end of the current-limiting resistor with the voltage at the first end of the current-limiting resistor, and output a discharge wake-up detection signal to wake up the battery management assembly.

The technical solution of the present application wakes up the corresponding battery management assembly through the corresponding wake-up detection assembly, which greatly reduces the cost of installation and maintenance. Specifically, when the charge-discharge control and detection assembly of the lithium battery of the high voltage group detects that the discharge switch is turned on or the charger-assisted power is valid, the corresponding charge-discharge control signal is output to wake up the connected battery management assembly and control the corresponding current-limiting charge-discharge switch assembly, thereby realizing the electrical connection between the battery core assembly and the power output end. In this way, the battery core assembly limits the current and discharges to the power supply output end. The remaining batteries of the high voltage group in the series-parallel battery system wake up the connected battery management assembly through parallel wake-up detection assembly, and batteries of low voltage group wake up the connected battery management assembly through the discharge wake-up detection assembly. Without the need for additional cables or devices to distribute copied user control signals to all batteries, the technical solution is simpler and reduces costs.

### BRIEF DESCRIPTION OF THE DRAWINGS

In order to more clearly illustrate the technical solutions in the embodiments of the present application or in the related art, drawings in the embodiments or in the related art will be briefly described below. Obviously, the drawings in the following description are only some embodiments of the present application. Other drawings can be obtained by those skilled in the art according to the structures shown in the drawings without creative work.

FIG. 1 is an overall block view of a battery wake-up circuit in a series-parallel battery system according to some embodiments of the present application.

FIG. 2 is a circuit view of a current-limiting charge-discharge switch assembly of the battery wake-up circuit in a series-parallel battery system according to some embodiments of the present application.

FIG. 3 is a schematic view of modules of the battery wake-up circuit in a series-parallel battery system according to some embodiments of the present application.

FIG. 4 is a circuit view of a parallel wake-up detection assembly of the battery wake-up circuit in a series-parallel battery system according to some embodiments of the present application.

FIG. 5 is a circuit view of a discharge wake-up detection assembly of the battery wake-up circuit in a series-parallel battery system according to some embodiments of the present application.

The realization of the purpose, functional characteristics and advantages of the present application will be further described with reference to the attached drawings in combination with embodiments.

### DETAILED DESCRIPTION OF THE EMBODIMENTS

The technical solutions of embodiments of the present application will be clearly and completely described with reference to the drawings of the present application. Obviously, the described embodiments are only some rather than all of the embodiments of the present application. Based on the embodiments of the present application, all other embodiments obtained by those skilled in the art without creative efforts shall fall within the scope of the present application.

In addition, the descriptions related to “first”, “second” and the like in the present application are merely for descriptive purposes, and should not be understood as indicating or implying their relative importance or implicitly indicating the number of technical features indicated. Therefore, the features defined by “first” and “second” may explicitly or implicitly include at least one such feature. Besides, the various embodiments can be combined with each other, but the combination must be based on what can be achieved by those skilled in the art. When the combination of the embodiments is contradictory or cannot be achieved, it should be considered that such combination does not exist, or is not within the scope of the present application.

In a battery system in which multiple lithium batteries are connected in series and parallel, the device provides only one power on/off control signal and charger-assisted power on/off signal to the battery system. In order to ensure that all series and parallel batteries operate synchronously under the action of user control signals, the user control signals need to be copied and distributed to all batteries. Two methods are usually used to achieve synchronization of all batteries and user control signals. One is to connect the user control signal to each battery through a cable, and the other is to send the user control signal to all other batteries through wireless or wired communication. Sending user control signals through wireless or wired communication requires keeping the battery communication circuit turned on at all times, which is not conducive to low-power management of batteries in non-working states. However, connecting user control signals to each battery through cables adds a lot of connecting cables, which not only reduces the reliability of the system, but also increases the cost of installation and maintenance.

In order to solve the above problems, the present application proposes a battery wake-up circuit in a series-parallel battery system. The wake-up circuit in the series-parallel battery system can wake up all batteries synchronously after the charge and discharge control signal is valid, without laying signal cables.

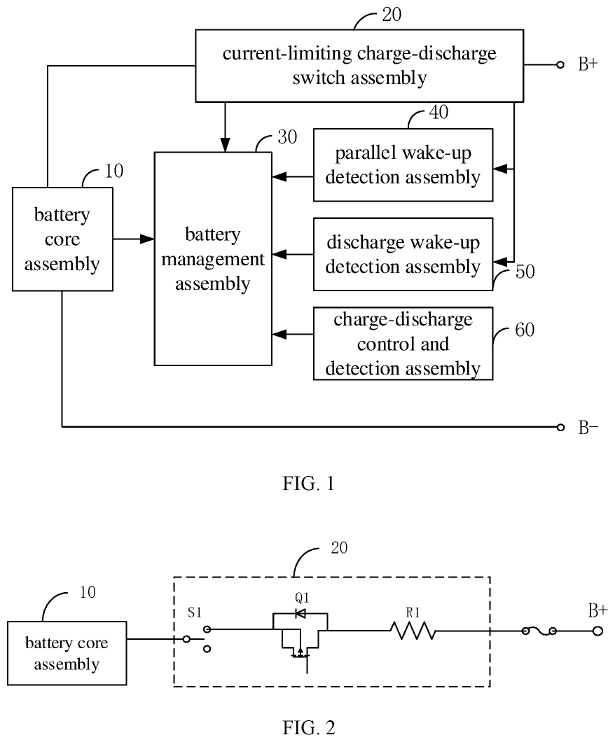

As shown in FIGS. 1 to 2, in some embodiments, the battery wake-up circuit in a series-parallel battery system includes a battery core assembly 10; a battery management assembly 30; a current-limiting charge-discharge switch assembly 20, a charge-discharge control and detection assembly 60 and a wake-up detection assembly.

The current-limiting charge-discharge switch assembly 20 is provided in series between the battery core assembly 10 and a power output end; and a controlled end of the current-limiting charge-discharge switch assembly 20 is connected to the battery management assembly 30;

The charge-discharge control and detection assembly 60 is connected to the battery management assembly 30; the charge-discharge control and detection assembly 60 is configured to detect a signal of a discharge switch and a signal of a charger-assisted power, and wake up the battery management assembly 30 in response to detecting a valid signal; and the battery management assembly 30 after being waken up is configured to control the current-limiting charge-discharge switch assembly 20 to realize a connection between the battery core assembly 10 and the power output end, thereby making a current-limiting discharge from the battery core assembly 10 to the power output end;

A detection end of the wake-up detection assembly is connected to one end or two ends of a current-limiting resistor R1 in the current-limiting charge-discharge switch assembly 20; and an output end of the wake-up detection assembly is connected to the battery management assembly 30;

The wake-up detection assembly is configured to detect a one-end voltage at the one end of the current-limiting resistor or a two-ends voltage difference between the two ends of the current-limiting resistor R1 in the current-limiting charge-discharge switch assembly 20; and in response that the one-end voltage or the two-ends voltage difference reaches a preset voltage, the wake-up detection assembly is further configured to output a wake-up detection signal to wake up the battery management assembly 30.

The current-limiting charge-discharge switch assembly may include the current-limiting resistor R1, a switch transistor Q1 and a relay S1. A first end of the current-limiting resistor R1 is connected to the power output end, a first end of the switch transistor Q1 is connected to one end of the relay S1, a second end of the switch transistor Q1 is connected to a second end of the current-limiting resistor R1, and a controlled end of the switch transistor Q1 is connected to the battery management assembly 30, and the other end of the relay S1 is connected to the battery core assembly 10.

Further, the switch transistor Q1 is a MOS transistor. The relay S1 is a normally closed relay. When the normally closed relay S1 is not powered or inactive, the contact state is closed, which means it is connected. It can be understood that after the battery management assembly 30 is awakened, the switch transistor Q1 connected to the battery management assembly 30 can be controlled to be turned on. At this time, the relay S1 is turned on and the switch transistor Q1 is turned on, which can make the battery core assembly 10 connected to the power output end, that is, the battery core assembly 10 discharges to the power output end.

The battery management assembly 30 can be a controller, such as MCU, digital signal processing (DSP) chip, field programmable gate array (FPGA) chip, system on chip (SOC) and so on. The battery management assembly 30 can be awakened by the charge-discharge control signal/wake-up detection signal, and control the operation of the current-limiting charge-discharge switch assembly 20 connected thereto to realize the electrical connection between the battery core assembly 10 and the power output end, so that the battery core assembly 10 can be connected and discharge to the power output end.

The wake-up detection assembly can be any detection circuit that can detect voltage differences, such as a comparator. It can be understood that the wake-up detection assembly can detect the voltage at one end of the current-limiting resistor R1 in the current-limiting charge-discharge switch assembly 20 or the voltage difference between both ends, and output a wake-up detection signal to wake up the corresponding battery management assembly 30. The charge-discharge control and detection assembly 60 detects the discharge switch signal and the charger-assisted power signal. The discharge switch can be any switch, such as a button switch, a boat-shaped switch, etc. In these embodiments, after detecting that the discharge switch signal or the charger-assisted power signal is valid, the charge-discharge control and detection assembly 60 outputs the charge and discharge control signal to wake up the battery management assembly 30 connected thereto. After the battery management assembly 30 is awaken by the charge-discharge control signal, the current-limiting charge-discharge switch assembly 20 connected thereto is controlled to realize the electrical connection between the battery core assembly 10 and the power output end.

In the series-parallel battery system, there is a battery of high-voltage group connected to the discharge switch or charger-assisted power. The battery management assembly 30 is awaken by the parallel wake-up detection assembly 40. The parallel wake-up detection assembly 40 detects the voltage at the power output end, that is, the voltage at the first end of the current-limiting resistor R1. When it is detected that the voltage reaches the preset voltage, a parallel wake-up detection signal is output.

The battery management assembly 30 of the low voltage group in the series-parallel battery system is awoken by the discharge wake-up detection assembly 50. The discharge wake-up detection assembly 50 detects the two-ends voltage difference between the two ends of the current-limiting resistor R1, and after detecting that the two-ends voltage difference reaches the preset voltage, a discharge wake-up detection signal is output. It should be noted that the discharge wake-up detection assembly 50 detects the voltage drop on the current-limiting resistor R1 to output a discharge wake-up detection signal. It can be understood that in these embodiments, the corresponding wake-up detection assembly 50 wakes up the corresponding battery management assembly 30.

In the technical solution of the present application, the corresponding battery management assembly 30 is waken up through the corresponding wake-up detection assembly 50, thereby reducing the cost of installation and maintenance. Specifically, after the charge-discharge control and detection assembly 60 detects that the discharge switch signal or the charger-assisted power signal is valid, the charge-discharge control signal is output, the battery management assembly 30 connected thereto is waken up, and the corresponding current-limiting charge-discharge switch assembly 20 is controlled to realize the electrical connection between the battery core assembly 10 and the power output end, so that the battery core assembly 10 limits current and discharges to the power output end. The battery of the high voltage group and the battery of the low voltage group in the series-parallel battery system wake up the battery management assembly 30 connected thereto through the parallel wake-up detection assembly 40 and the discharge wake-up detection assembly 50 respectively, without the need for additional cables or devices to distribute the copied user control signals to all batteries, which is simpler and reduces costs. Compared with transmitting user control signals to each battery in the system through signal cables, the battery wake-up circuit in the series-parallel battery system proposed by the present application is designed according to the characteristics of batteries at different positions in the series-parallel battery system. The current-limiting charge-discharge switch assembly 20 can automatically adjust its state according to different properties of the battery, and the battery with different properties can be awaken by changing the voltage/voltage drop at the current-limiting resistor R1. There is no need to keep the communication circuit turned on for a long time, resulting in lower power consumption and no need for additional cables or devices, which improves the reliability of the system and also reduces installation and maintenance costs.

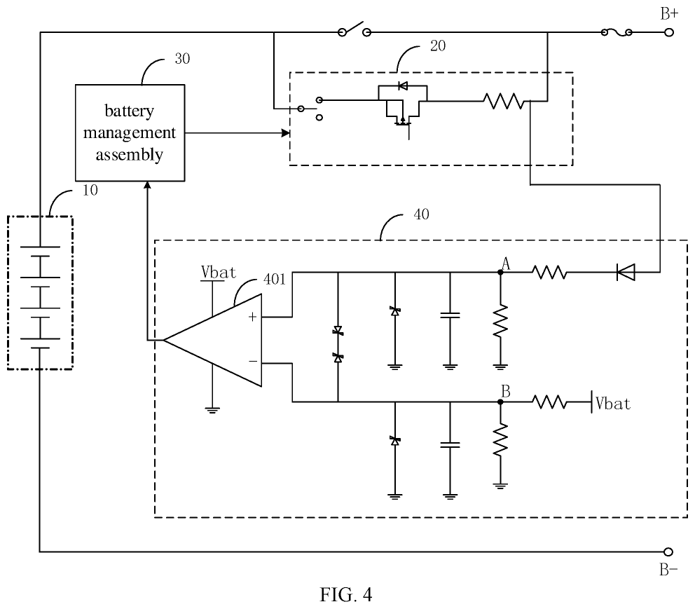

As shown in FIG. 1 and FIG. 4, in some embodiments, the series-parallel battery system includes a plurality of lithium batteries of high voltage group, and a plurality of lithium batteries of low voltage group. The wake-up detection assembly 50 includes a parallel wake-up detection assembly 40.

A detection end of the parallel wake-up detection assembly 40 is connected to the first end of the current-limiting resistor R1; and an output end of the parallel wake-up detection assembly 40 is connected to the battery management assembly 30, the parallel wake-up detection assembly 40 is configured to detect the one-end voltage at the first end of the current-limiting resistor R1, and in response that the one-end voltage reaches the preset voltage, the parallel wake-up detection assembly 40 is further configured output a parallel wake-up detection signal to wake up the battery management assembly 30.

Further, the parallel wake-up detection assembly 40 includes a first comparator 401. A positive input end of the first comparator 401 is connected to the first end of the current-limiting resistor R1, a negative input end of the first comparator 401 is connected to a positive end of a battery core assembly 10 of a lithium battery of the high voltage group, an output end of the first comparator 401 is connected to the battery management assembly 30, the first comparator 401 is configured to compare a voltage of the first end of the current-limiting resistor R1 with a voltage of the positive end of the battery core assembly 10 of the lithium battery of the high voltage group, and output the parallel wake-up detection signal to wake up the battery management assembly 30.

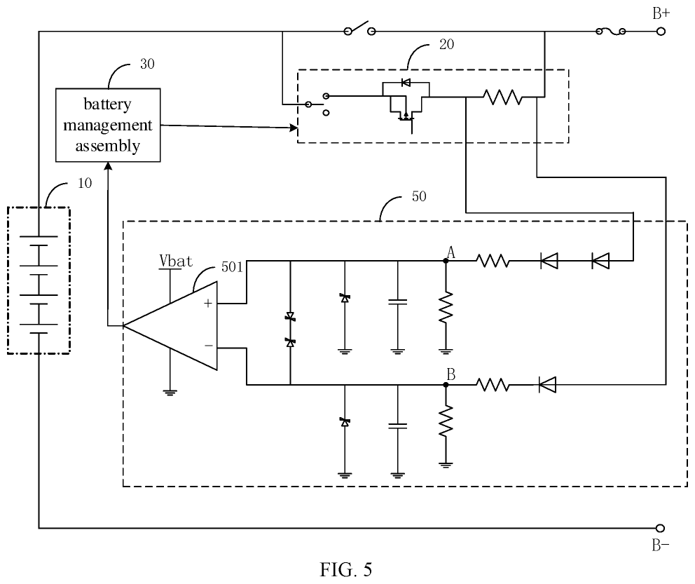

As shown in FIG. 1 and FIG. 5, in some embodiments, the wake-up detection assembly further includes a discharge wake-up detection assembly 50. A detection end of the discharge wake-up detection assembly 50 is connected to the two ends of the current-limiting resistor R1; and an output end of the discharge wake-up detection assembly 50 is connected to the battery management assembly 30. The discharge wake-up detection assembly 50 is configured to detect the two-ends voltage difference between the two ends of the current-limiting resistor R1, and in response that the two-ends voltage difference reaches the preset voltage, the discharge wake-up detection assembly 50 is further configured to output a discharge wake-up detection signal to wake up the battery management assembly 30.

The discharge wake-up detection assembly 50 includes a second comparator 501. A positive input end of the second comparator 501 is connected to the second end of the current-limiting resistor R1, a negative input end of the second comparator 501 is connected to the first end of the current-limiting resistor R1, an output end of the second comparator 501 is connected to the battery management assembly 30, the second comparator 501 is configured to compare a voltage of the second end of the current-limiting resistor R1 with the voltage of the first end of the current-limiting resistor R1, and output a discharge wake-up detection signal to wake up the battery management assembly 30.

In these embodiments, after the battery management assembly 30 corresponding to any high voltage group lithium battery in the series-parallel battery system is waken up through the charge-discharge control detection assembly 60, the battery management assembly 30 controls the current-limiting charge-discharge switch assembly 20 to work, that is, it controls the battery core assembly 10 of the battery to be electrically connected to the power output end to discharge. The parallel wake-up detection assembly 40 of other high-voltage group lithium batteries in the series-parallel system outputs the corresponding parallel wake-up detection signal to wake up the corresponding battery management assembly 30. The battery management assembly 30 turns on the corresponding current-limiting charge-discharge switch assembly 20, and all the cell assembly 10 of high voltage group lithium batteries are electrically connected to the corresponding power output end. At the same time, since the current-limiting charge-discharge switch assembly 20 of the low voltage group lithium battery is in a conducting state when the battery is turned off, the high voltage group battery and the low voltage group battery charges the device load capacitance through their respective current-limiting charge-discharge switch assemblies 20. The charging current of the device load capacitance will produce a voltage drop on the current limiting resistor R1 in all current-limiting charge-discharge switch assemblies 20. When the voltage drop reaches the wake-up threshold, the discharge wake-up detection assembly 50 of the low-voltage group lithium battery outputs the discharge wake-up detection signal to wake up the corresponding battery management assembly 30. It is worth noting that the current-limiting charge-discharge switch assembly 20 connected to the battery core assembly 10 in the low voltage group lithium battery is in a conductive state when the battery is turned off, that is, the relay S1 is turned on and the switch transistor Q1 is turned on.

Compared with transmitting user control signals to each battery in the system through signal cables or communication means such as wireless communication and wired communication, the battery wake-up circuit in the series-parallel battery system proposed by the present application is based on the characteristics of batteries in different positions of the series-parallel battery system. A current-limiting charge-discharge switch assembly 20 whose state can be automatically adjusted according to the battery properties is provided. Batteries with different properties can be awakened through changes in the voltage and voltage drop of the current-limiting resistor R1. There is no need to keep the communication circuit on for a long time, the power consumption is much low and no additional cables or devices are required, which improves system reliability and reduces installation and maintenance costs.

In order to better illustrate the inventive concept of the present application, the working principle of the present application is described below in conjunction with the above embodiments:

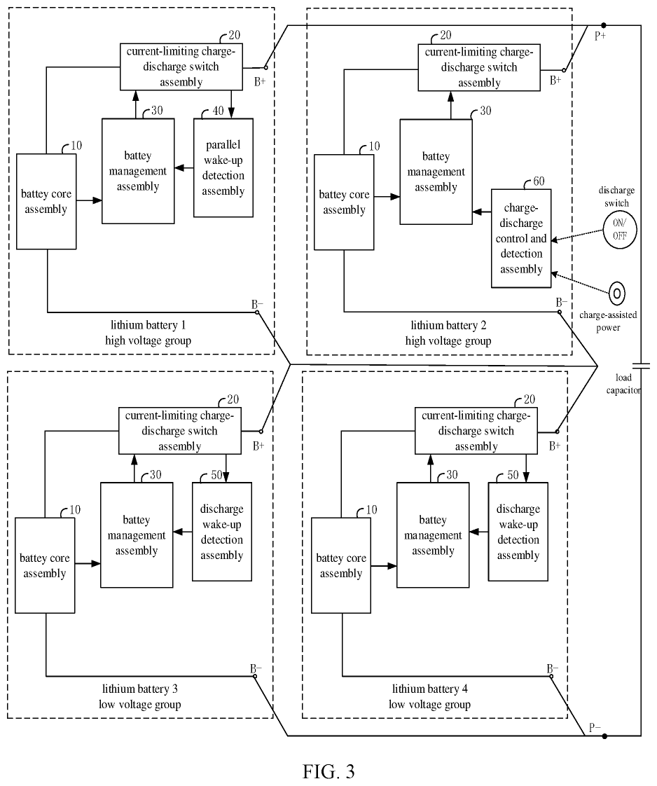

With reference to FIGS. 2 to 4, the implementation of parallel wake-up detection and its application in high-voltage group batteries are described. It should be noted that in a series-parallel battery system, the lithium battery with the highest voltage in series, that is, all the batteries in the parallel group with the highest voltage in the series-parallel battery system, is classified to the high voltage group. As shown in FIG. 3, lithium battery 1 and lithium battery 2 are batteries belong to high voltage group. In the series-parallel battery system, except for batteries belonging to the high voltage group, all other batteries are classified to the low-voltage group. Taking FIG. 3 as an example, lithium battery 3 and lithium battery 4 belong to low voltage group.

The parallel wake-up detection assembly 40 is composed of a first comparator 401, a positive terminal input protection diode, a positive terminal voltage dividing network resistor, a negative terminal voltage dividing network resistor, an anti-false triggering filter capacitor, and an over-voltage protection diode. When the battery of the high voltage group is in the shutdown state, the contactor is in the disconnected state, the relay S1 is in the disconnected state, the switch tube Q1 is in the closed state, the power output end B+ has no voltage, and the voltage at the positive input terminal A of the first comparator 401 is zero. The negative input terminal B of the first comparator 401 generates a voltage of 0.4*Vbat from the positive terminal of the battery through the voltage dividing network resistor. The first comparator 401 outputs a low level in the battery shutdown state and cannot wake up the battery management assembly 30.

When other high voltage batteries connected in parallel with this battery are turned on through the charge-discharge control and detection assembly 60 and the current-limiting charge-and discharge switch assembly 20 is turned on, due to the parallel connection, the voltage at B+ terminal of the battery will be the same as the voltage of the opened high voltage group batteries. After this voltage passes through the input protection diode, a voltage drop of about 0.8V is generated, and then a voltage of 0.5*Vbat minus 0.4V is generated at point A through the voltage dividing network resistor. Since the effective voltage of the battery core assembly 10 of a 12V lithium battery is 8.4 V˜14.4V, therefore the voltage of the positive input terminal A of the first comparator 401 will be greater than the voltage of the negative input terminal B, and the first comparator 401 outputs a high level to wake up the corresponding battery management assembly 30.

With reference to FIGS. 2, 3 and 5, the implementation of discharge wake-up detection and its application in batteries of low voltage group are described. The discharge wake-up detection assembly 50 is composed of a second comparator 501, a positive terminal input protection diode, a positive terminal input buck diode, a positive terminal voltage dividing network resistor, a negative terminal input protection diode, a negative terminal voltage dividing network resistor, an anti-false triggering filter capacitors and an over-voltage protection diodes. When the battery of low-voltage group is in the shutdown state, the contactor is in the disconnected state, the relay S1 is in the on state, the switch tube Q1 is in the open state, and the voltage of the power output end B+ is consistent with the voltage Vbat of the positive terminal of the battery. The voltage Vin+ at the positive input terminal A of the second comparator 501 is: Vin+=(Vbat−Vd1−Vd2)/2=(Vbat−Vd1)/2−Vd2/2, and the voltage Vin− at the negative input terminal B of the second comparator 501 is: Vin−=(Vbat−Vd3)/2. The positive input protection diode and the negative input protection diode are of the same model, that is, Vd1=Vd3. Therefore, Vin+ is smaller than Vin−, and the second comparator 501 outputs low voltage and the battery management assembly 30 will not be waken up.

When a battery of a certain high voltage group in the system is turned on through the charge-discharge control and detection assembly 60, the battery management assembly 30 of the battery is awakened, the relay S1 is turned on, and the switch transistor Q1 is turned on. All batteries of low voltage group and the batteries of the opened high voltage group together charge the device load capacitance through their respective current-limiting resistors R1. Assume that the discharge current flowing through each low voltage group battery is Idis, and the voltage drop generated across the current limiting resistor R1 is Rlim*Idis. At this time, the voltage Vin+ at the positive input terminal A of the second comparator 501 is still: Vin+32 (Vbat−Vd1−Vd2)/2=(Vbat−Vd1)/2−Vd2/2, and the voltage Vin− at point B of the negative input terminal of the second comparator 501 becomes: Vin−=(Vbat−Rlim*Idis−Vd3)/2=(Vbat−Rlim*Idis)/2−Vd3/2. By reasonably selecting the resistance of the current-limiting resistor R1, the voltage difference Vd2 generated by D2 is less than Rlim*Idis, and Vin+ will be greater than Vin−. The second comparator 501 outputs a high level, and the battery management assembly 30 is awakened.

Referring to the system with two-series and two-parallel 24V lithium shown in FIG. 3, the discharge switch for turning on the system and the charger-assisted power signal are connected to the charge-discharge control and detection assembly 60 of the high voltage group lithium battery 2, lithium battery 1 and lithium battery battery 2 belong to a high-voltage group, and lithium battery 3 and lithium battery 4 belong to low voltage group. When the charge-discharge control and detection assembly 60 of the lithium battery 2 detects the discharge switch signal or the charger-assisted power signal, the battery management assembly 30 of the lithium battery 2 is awakened, the relays S1 in the current-limiting charge-discharge switch assembly is turned on and the switch transistor Q1 is turned on. The voltage of the battery core assembly 10 of the lithium battery 2 is output to the power terminal B+. Since lithium battery 1 and lithium battery 2 are connected in parallel, the voltage is output to the B+ terminal of lithium battery 1 at the same time. The parallel wake-up detection assembly 40 of lithium battery 1 outputs a parallel wake-up detection signal, and the battery management assembly 30 of lithium battery 1 starts working.

Due to the existence of the device load capacitance, when lithium battery 2 turns on relay S1 and turns on switch transistor Q1, since lithium battery 3 and lithium battery 4 belong to low voltage group, when lithium battery 3 and lithium battery 4 are shut down, the relay S1 inside the battery is turned on and switch transistor Q1 is turned on. Therefore, all of lithium battery 2, lithium battery 3, and lithium battery 4 discharged through their respective current-limiting resistors R1 to charge the load capacitor. The discharge current Idis will generate a voltage drop Rlim*Idis at the current-limiting resistor R1. When the voltage drop is greater than Vd2, the discharge wake-up circuit of lithium battery 3 and lithium battery 4 generates a discharge wake-up detection signal, and the battery management assemblies 30 of lithium battery 3 and lithium battery 4 start working.

Compared with transmitting user control signals to each battery in the system through signal cables or communication means such as wireless communication and wired communication, the battery wake-up circuit in the series-parallel battery system proposed by the present application is based on the characteristics of batteries in different positions of the series-parallel battery system. A current-limiting charge-discharge switch assembly 20 whose state can be automatically adjusted according to the battery properties is provided. Batteries with different properties can be awakened through changes in the voltage and voltage drop of the current-limiting resistor R1. There is no need to keep the communication circuit on for a long time, the power consumption is much lower and no additional cables or devices are required, which improves system reliability and reduces installation and maintenance costs.

It should be noted that the above are only some embodiments of the present application, and do not limit the scope of the present application thereto. Under the concept of the present application, equivalent structural transformations made according to the description and drawings of the present application, or direct/indirect application in other related technical fields are included in the scope of the present application.

What is claimed is:

1. A battery wake-up circuit in a series-parallel battery system, comprising:
a battery core assembly;
a battery management assembly;
a current-limiting charge-discharge switch assembly provided in series between the battery core assembly and a power output end; wherein a controlled end of the current-limiting charge-discharge switch assembly is connected to the battery management assembly;
a charge-discharge control and detection assembly connected to the battery management assembly; wherein the charge-discharge control and detection assembly is configured to detect a signal of a discharge switch and a signal of a charger-assisted power, and wake up the battery management assembly in response to detecting a valid signal; and the battery management assembly after being waken up is configured to control the current-limiting charge-discharge switch assembly to realize an electrical connection between the battery core assembly and the power output end, thereby making a current-limiting discharge from the battery core assembly to the power output end; and
a wake-up detection assembly; wherein a detection end of the wake-up detection assembly is connected to one end or two ends of a current-limiting resistor in the current-limiting charge-discharge switch assembly; and an output end of the wake-up detection assembly is connected to the battery management assembly; the wake-up detection assembly is configured to detect a one-end voltage at the one end of the current-limiting resistor or a two-ends voltage difference between the two ends of the current-limiting resistor; and in response to that the one-end voltage or the two-ends voltage difference reaches a preset voltage, the wake-up detection assembly is further configured to output a wake-up detection signal to wake up the battery management assembly which is connected to the wake-up detection assembly.

2. The battery wake-up circuit in a series-parallel battery system according to claim 1, wherein the current-limiting charge-discharge switch assembly comprises the current-limiting resistor, a switch transistor and a relay; a first end of the current-limiting resistor is connected to the power output end, and a first end of the switch transistor is connected to one end of the relay; a second end of the switch transistor is connected to a second end of the current-limiting resistor, and a controlled end of the switch transistor is connected to the battery management assembly; the other end of the relay is connected to the battery core assembly.

3. The battery wake-up circuit in a series-parallel battery system according to claim 2, wherein the wake-up detection assembly comprises a parallel wake-up detection assembly;
a detection end of the parallel wake-up detection assembly is connected to the first end of the current-limiting resistor, and an output end of the parallel wake-up detection assembly is connected to the battery management assembly; and
the parallel wake-up detection assembly is configured to detect a voltage at the first end of the current-limiting resistor, and in response to that the voltage at the first end of the current-limiting resistor reaches the preset voltage, the parallel wake-up detection assembly is further configured to output a parallel wake-up detection signal to wake up the battery management assembly.

4. The battery wake-up circuit in a series-parallel battery system according to claim 3, wherein the wake-up detection assembly further comprises a discharge wake-up detection assembly;
a detection end of the discharge wake-up detection assembly is connected to the two ends of the current-limiting resistor, and an output end of the discharge wake-up detection assembly is connected to the battery management assembly; and
the discharge wake-up detection assembly is configured to detect the two-ends voltage difference between the two ends of the current-limiting resistor, and in response that the two-ends voltage difference reaches the preset voltage, the discharge wake-up detection assembly is further configured to output a discharge wake-up detection signal to wake up the battery management assembly.

5. The battery wake-up circuit in a series-parallel battery system according to claim 4, wherein the series-parallel battery system comprises a plurality of lithium batteries connected in series and parallel to each other;
among the plurality of lithium batteries connected in series and parallel to each other, a lithium battery with a highest series voltage is distributed to a high voltage group, and the remaining lithium batteries except the high voltage group are distributed to a low voltage group.

6. The battery wake-up circuit in a series-parallel battery system according to claim 5, wherein the parallel wake-up detection assembly comprises a first comparator;
a positive input end of the first comparator is connected to the first end of the current-limiting resistor, and a negative input end of the first comparator is connected to a positive end of a battery core assembly of a lithium battery of the high voltage group; an output end of the first comparator is connected to the battery management assembly; and
the first comparator is configured to compare the voltage at the first end of the current-limiting resistor with a voltage of the positive end of the battery core assembly of the lithium battery of the high voltage group, and output the parallel wake-up detection signal to wake up the battery management assembly.

7. The battery wake-up circuit in a series-parallel battery system according to claim 6, wherein the discharge wake-up detection assembly comprises a second comparator;
a positive input end of the second comparator is connected to the second end of the current-limiting resistor, and a negative input end of the second comparator is connected to the first end of the current-limiting resistor; an output end of the second comparator is connected to the battery management assembly; and
the second comparator is configured to compare a voltage at the second end of the current-limiting resistor with the voltage at the first end of the current-limiting resistor, and output a discharge wake-up detection signal to wake up the battery management assembly.
